(19) United States
(12) Patent Application Publication
(10) Pub. No.: US 2003/0157911 A1
(43) Pub. Date: Aug. 21, 2003

(54) Transmission-reception head

(76) Inventors: Danilo Gerna, Grenoble (FR); Didier Belot, Rives (FR); Vincent Knopik, Lancey (FR)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/257,210

(22) PCT Filed: Dec. 7, 2001
(86) PCT No.: PCT/FR01/03915

(30) Foreign Application Priority Data
Dec. 8, 2000 (FR) 00/16034

(51) Int. Cl. H04B 1/00

(52) U.S. Cl. 455/144; 455/91; 455/194.2

(57) ABSTRACT

A head of transmission-reception of a high-frequency signal made in the form of an integrated circuit including a transmit amplifier and a receive amplifier. The transmit terminal of the transmit amplifier and the receive terminal of the receive amplifier are interconnected in a common transmit/receive terminal. The head includes means for selecting one of the amplifiers and means for placing the other amplifier in a high impedance state, as seen from the transmit/receive terminal.

### BACKGROUND OF THE INVENTION

1. Technical Field

The present invention relates to the transmission of data between devices of a local network, that is, over short distances, shorter than approximately some ten meters, at frequencies of the radio frequency field. More specifically, the present invention relates to the forming of transmit/receive heads intended for being used in communications between two elements of a local network.

2. Description of the Related Art

FIG. 1 schematically illustrates, by functional blocks, an example of such a head. The head includes a digital circuit 1 (CU) which processes the data received/transmitted from reference signals provided by a local oscillator 2 (LO). Generally, digital circuit 1 receives from local oscillator 2 a signal and its complement in phase quadrature. The reference signals are mixed, by mixers 3 and 4, with signals respectively transmitted or received by a modulator 5 (MOD) or a demodulator 6 (DEMOD). The modulated signal mixed to the reference signals is provided to a transmit amplifier 7 (AMP), generally a power amplifier. Output 8 of power amplifier 7 forms an output terminal of a first chip 15, delimited in FIG. 1 by dotted lines, integrating a portion of the transmit/receive head. Output 8 is connected to an impedance matching circuit 9 (Z), having its output connected to a first terminal or input terminal of a three-point bidirectional switch 10 (SELECT). A second terminal or input/output terminal of switch 10 is associated with a block 11 (COUPL) including an antenna coupler and an antenna.

A signal received by block 11 is transmitted, by a third terminal or output terminal of switch 10 and an impedance matching circuit 12 (Z′), to an input terminal 13 of chip 15. Terminal 13, distinct from output terminal 8, forms the input of a low-noise receive amplifier 14 (LNA), having its output connected to demodulator 6 by mixer 4.

In a conventional head, only the digital processing stage, the modulation/demodulation stage and the transmit and receive amplifiers are integrable on a same chip 15, as has been previously detailed. Chip 15 then includes two distinct input (13) and output (8) terminals. The impedance matching circuits (9 and 12) are integrated separately. Block 11 is also integrated separately. Three-point bidirectional switch 10, which is relatively bulky, is generally also separately integrated. Switch 10 is then necessary in these systems to enable alternation of receive and transmit operations. Indeed, systems dedicated to operating either in receive mode or in transmit mode (half-duplex), and not simultaneously in transmit and receive mode (full-duplex) are considered in the present description.

Such transmit/receive heads are now used in mobile devices such as, for example, telephones, organizers, portable phones, to enable transferring data to a fixed central station, or other peripherals. To reduce the size of portable devices, it is desirable to individually reduce the size of each component and especially of secondary devices such as these additional transmit/receive devices.

### SUMMARY OF THE INVENTION

The present invention accordingly aims at providing a radio frequency transmit/receive head intended for being used in a local network, having a reduced bulk.

The present invention more specifically aims at suppressing the particularly bulky three-point bidirectional switch 10.

To achieve these objects, the present invention provides a head of transmission-reception of a high-frequency signal made in the form of an integrated circuit including a transmit amplifier and a receive amplifier. The transmit terminal of the transmit amplifier and the receive terminal of the receive amplifier are interconnected in said circuit in a transmit/receive terminal, and the head includes means for selecting one of the amplifiers and means adapted to placing the other amplifier in a high impedance state, seen from the transmit/receive terminal.

According to an embodiment of the present invention, the means adapted to selecting one of the amplifiers include controllable elements adapted to interrupting at least one signal for biasing at least one input or output element of said amplifiers.

According to an embodiment of the present invention, at least one of said controllable elements is a one-way switch adapted to being controlled to branch towards a ground of the integrated circuit said biasing signal.

According to an embodiment of the present invention, all controllable elements are one-way switches adapted to being controlled to each branch, towards the ground, at least one bias signal, and the head includes a control circuit common to said switches.

According to an embodiment of the present invention, the means adapted to selecting the receive amplifier and placing it in a high impedance state when it is not selected are conjoined. According to an embodiment of the present invention, the receive amplifier includes, connected in series between a high power supply and the ground, an inductor-capacitor oscillating circuit, a cascode assembly, and a current source; at least one gate of a MOS transistor belonging to said cascode assembly being connected to at least one bias source.

According to an embodiment of the present invention, the cascode assembly includes at least two transistors, the gates of the transistors being interconnected to the bias source.

According to an embodiment of the present invention, the cascode assembly includes at least two transistors, the gates of the transistors being individually connected to distinct bias sources.

According to an embodiment of the present invention, the transmit amplifier includes, interconnected between a high supply rail and a circuit ground, a one-way switch adapted to receiving a control signal from a control circuit, an inductor-capacitor oscillating circuit, an N-type MOS transistor, a capacitor being further interposed between the ground and the midpoint of the series connection of the one-way switch and of the resonant circuit, and the transistor gate receiving said bias signal and a transmit control signal coming from an input terminal of the transmit amplifier.

According to an embodiment of the present invention, a controllable one-way switch is interposed between the gate of said transistor and the ground.

The foregoing objects, features and advantages of the present invention will be discussed in detail in the following non-limiting description of specific embodiments in connection with the accompanying drawings.

### BRIEF DESCRIPTION OF THE DRAWINGS

FIG. 1 illustrates a conventional transmit/receive head;

FIG. 2 illustrates in the form of functional blocks a transmit/receive head according to the present invention; and

FIG. 3 illustrates an embodiment of a transmit/receive head according to the present invention.

### DETAILED DESCRIPTION OF THE INVENTION

For clarity, the same elements have been designated with the same references in the different drawings.

A feature of the present invention is to the three-point bidirectional switch. This results in interconnecting the output of the transmit power amplifier to the input of the low-noise receive amplifier. This is however not sufficient. Indeed, even when idle (when it receives no input signal), a power amplifier of the type of the transmit amplifier generates noise. This noise, which is generally associated with an output impedance of the transmit amplifier, as seen from the output, with a relatively high but not infinite value, is a negligible signal for this amplifier, given the usual levels, on the order of one milliwatt. However, as seen from the low-noise amplifier, to which the output of the power amplifier is now connected, this signal has a very high level, comparable to the signal of a few microwatts received from the antenna block. The noise then completely covers the wanted signal coming from the antenna and the information transmitted by the demodulator and decoded by the digital circuit is erroneous.

Thus, another feature of the present invention is to provide selection of one of the amplifiers and to force the transmit or receive amplifier which has not been selected to take, as seen from the selected amplifier, a sufficiently high impedance state to be considered as infinite. Such a state will be considered to have been reached when any possible noise signal transmitted or sampled by the amplifier which has not been selected has a negligible level as compared to the wanted signal received or transmitted by the selected receive or transmit amplifier.

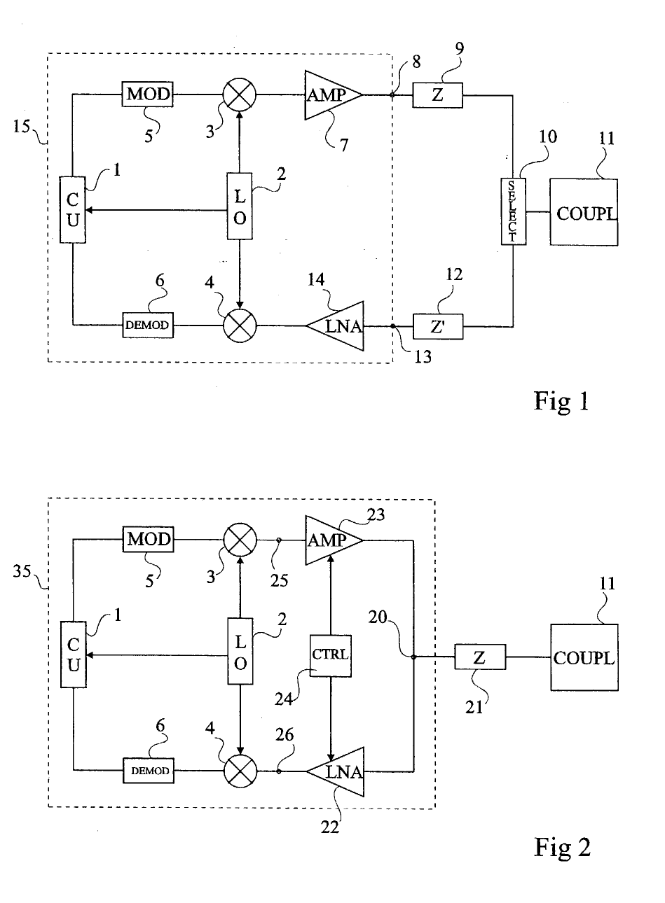

A transmit/receive head according to the present invention, such as illustrated in FIG. 2, differs from a conventional transmit/receive head illustrated in FIG. 1 by its input/output stage. According to the present invention, a transmit/receive head includes a single input-output (transmit/receive) terminal 20. Input/output terminal 20 is connected to an antenna coupler block 11 (COUPL) by a single impedance matching circuit 21. Input/output terminal 20 is a common input point of a receive amplifier 22 (LNA) and output point of a transmit amplifier 23 (AMP). Receive and transmit amplifiers 22 and 23 are controlled by a circuit 24 (CTRL) to select a single one of amplifiers 22 and 23. Amplifiers 22 and 23 are also designed to have, as seen from input/output terminal 20, a high impedance state when they are not selected. On the side of digital circuit 1, input 25 of transmit amplifier 23 is, as previously, connected to the output of mixer 3, and output 26 of receive amplifier 22 is connected, as previously, to an input of mixer 4. The inputs of mixer 3 are connected to the output of a modulator 5 (MOD) and to a local oscillator 2 (LO). Similarly, another input of mixer 4 is connected to oscillator 2 and its output is connected to the input of a demodulator (DEMOD) 6. As previously, the input of modulator 5 and the output of demodulator 6 are connected to digital circuit 1 which also receives the reference signals from local oscillator 2. Impedance matching circuit 21 and block 11 are integrated outside of the chip, illustrated by dotted lines 35, on which the previously-described elements are located.

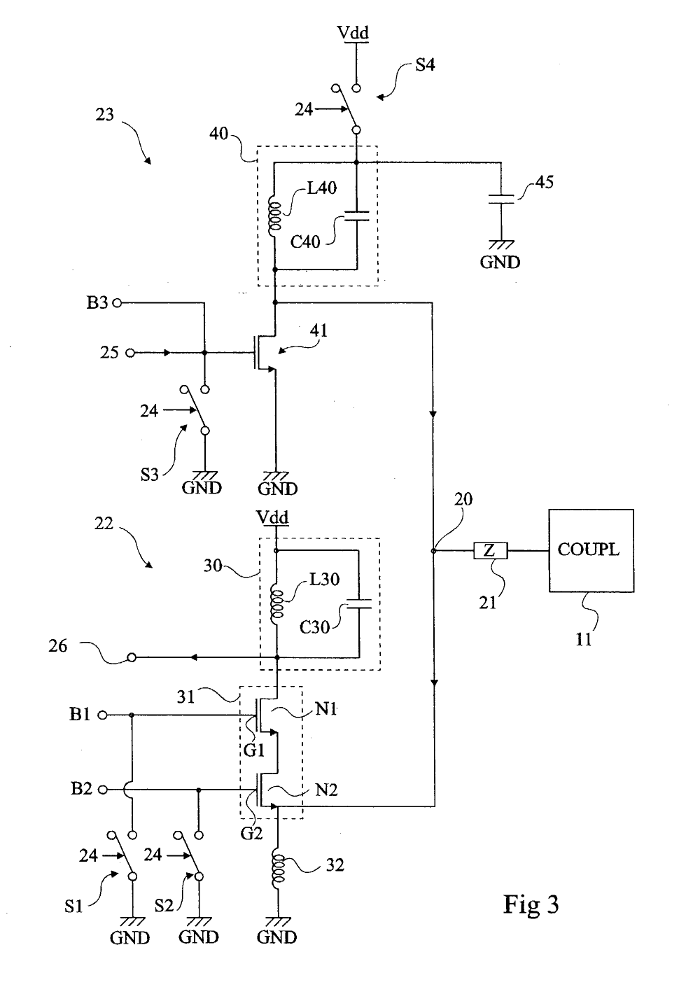

FIG. 3 illustrates an embodiment of receive and transmit amplifiers 22 and 23 according to the present invention.

A low-noise amplifier 22 according to the present invention includes, connected in series between a high supply rail Vdd and a low supply rail or circuit ground GND, an oscillating circuit 30, a cascode assembly 31, and an inductive winding 32. Oscillating circuit 30 is formed by the parallel connection of an inductive resistor L30 and of a capacitor C30. The interconnection node of inductive resistor L30 and capacitor C30, opposite to the node of connection to high power supply Vdd, forms output terminal 26 of low-noise receive amplifier 22. Cascode circuit 31 is connected between terminal 26 and transmit/receive terminal 20. Cascode circuit 31 is a source follower circuit formed of two N-type MOS transistors N1 and N2 in series. The drain of transistor N1 is connected to terminal 26 and its source is connected to the drain of transistor N2, the source of which is connected to terminal 20. The source of transistor N2 is also connected to a first terminal of inductive winding 32, the other terminal of which is connected to ground GND. Gates G1 and G2 of transistors N1 and N2 of cascode assembly 31 are each connected to a bias source symbolized by its respective output terminal B1 and B2. Inductive element 32 forms a current source and enables, with bias sources B1 and B2, setting the operating point of cascode circuit 31.

According to the present invention, the bias control of sources B1 and B2 can be interrupted to enable, as will better appear from the following description of low-noise amplifier 22, deselection thereof. For this purpose, preferably, the gate G1, G2, of each transistor N1, N2 is also connected to ground GND by a respective one-way switch S1, S2 including a control terminal. Switch S1 is interposed between gate G1 and bias source B1. Similarly, switch S2 is interposed between gate G2 and bias source B2. The control terminals of switches S1 and S2 each receive a signal from control circuit 24 (FIG. 2). Switches S1 and S2 are, as will better appear from the following description of the operation of low-noise amplifier 22, preferably, switches of the same type. Switches S1 and S2 thus both are either normally-on switches (which must be controlled to be turned off), or normally-off switches (which must be controlled to be turned on), or else switches which must be controlled to be turned on and off.

Amplifier 23 includes, connected in series between high power supply Vdd and ground GND, an oscillating circuit 40 and an N-type MOS transistor 41. The junction point of oscillating circuit 40 and transistor 41 forms the head's transmit terminal. Oscillating circuit 40, intended for amplifying the transmitted signal, is formed, like homologous circuit 30 of low-noise amplifier 22, of a parallel inductive-capacitive circuit L40, C40. The source of transistor 41 is connected to ground GND and its drain forms the head's transmit terminal. The gate of transistor 41 receives the signal modulated by modulator 5 (FIG. 2) and mixed by mixer 3 to the reference signals provided by local oscillator 2. The gate of transistor 41 is also connected to a bias source symbolized by its output terminal B3, to determine its operating point.

According to the present invention, the bias control of output element 41 of transmit amplifier 23 can be interrupted. For this purpose, preferably, the gate of transistor 41 is connected to ground GND of the circuit by a one-way switch S3 controlled by control circuit 24 (FIG. 2).

Power amplifier 23, according to the present invention, also includes, interposed between high power supply Vdd and oscillating circuit 40, a one-way switch S4 controlled by control circuit 24. Switch S4 enables modifying the impedance of power amplifier 23 according to its selected or non-selected state. Power amplifier 23 also includes a capacitor 45 interposed between ground GND and the midpoint of the series connection of oscillating circuit 40 with switch S4.

The operation of low-noise amplifier 22 is the following. When the head must receive data, switches S1 and S2 are off. Bias sources B1 and B2 of gates G1 and G2 turn transistors N1 and N2 on. Then, the signal received on antenna 11 is transmitted by impedance matching circuit 21 onto receive terminal 20, then arrives onto the source of transistor N2. It is then amplified by resonant circuit 30 and transmitted to input 26 of mixer 4 (FIG. 2).

Outside of receive phases, for example in an idle phase or during a phase of transmission from power amplifier 23, switches S1 and S2 are on and may be maintained in this state. The biasing of transistors N1 and N2 is then stopped and the transistors turn off. Any capacitive coupling between the drain and gate G1 of transistor N1, on the one hand, and the source and gate G2 of transistor N2, on the other hand, which could cause an unwanted turning-on of cascode circuit 31, is also made impossible by the turning-on of switches S1 and S2. Transistors N1 and N2 being off, the source of transistor N2 is, as seen from transmit/receive terminal 20, at an infinite impedance. Accordingly, the noise signal that it is likely to sample from a signal that may be transmitted by power amplifier 23 is negligible.

Upon turning-on of switches S1 and S2, as seen from transmit/receive terminal 20, only the real part of the impedance of low-noise amplifier 22 is modified. Indeed, the imaginary part of this impedance is set by the stray capacitances between gate G2 and the source of transistor N2, by the overlap capacitances between the gate and the conductor connecting it to the terminal of switch S2 distal from ground GND and to bias source B2, and by the capacitance between the source and the substrate of transistor N2. The turning-on of switches S1 and S2 suppresses only the stray capacitance between the gate and the source of transistor N2. This variation is very small and widely compensated for by the significant variation of the off-state resistance of cascode circuit 31, on the order of some thousand ohms.

Switches S1 and S2 thus enable selection, by their turning-off, of receive amplifier 22, or deselection thereof by their turning-on. This deselection is further performed so that the resistive impedance of this receive amplifier 22 according to the present invention can be considered as being infinite, as seen from transmit/receive terminal 20.

Bias sources B1 and B2 must have a low impedance at the operating frequency. Those skilled in the art will know how to combine these sources and drive them by means of a single switch.

The operation of power amplifier 23 is the following. When the head must transmit a signal, switch S3 is off and switch S4 is on. A digital signal provided by circuit 1 (FIG. 2) is sent to modulator 5 and mixed to the reference signals, provided by local oscillator 2, by mixer 3. The resulting signal is provided to input 25 of power amplifier 23. Switch S3 being off, this signal is transmitted to the gate of transistor 41. The signal is then transmitted, amplified by resonant circuit 40, onto transmit/receive terminal 20 of the circuit and transmitted, by impedance matching circuit 21, to block 11, to be transmitted to a distant device (not shown).

When power amplifier 23 is not selected, for example in a stand-by phase or in a phase of reception by low-noise amplifier 22, switch S3 is on. Then, bias source B3 and the transmit control signal of terminal 25 are pulled to ground GND. Transistor 41 turns off and remains in this state as long as switch S3 remains on. The impedance of power amplifier 23, as seen from terminal 20, then is the impedance of resonant circuit 40. The theoretically infinite quality factor of this circuit in practice has a relatively low value. The impedance seen from terminal 20 then is of a few hundred ohms only. The power stored in oscillating circuit 40 tends to dissipate in the form of a current of relatively high level with respect to a signal that may be received by terminal 20. The signal decoded by low-noise amplifier 22 is then completely drowned in this noise signal. To avoid this, switch S4 is off when switch S3 is on. Capacitor 45 then behaves as a high-frequency virtual ground and imposes a very low signal level, corresponding to a very high impedance, on the order of some thousand ohms, to the resonant circuit. The possible noise signal then is of a very low level, negligible as compared to a signal received by low-noise amplifier 22. By turning off switch S4, the impedance of oscillating circuit 40 is thus virtually modified (increased) as seen from transmit/receive terminal 20.

As previously discussed, switches S1 and S2 and switch S3 have the object of enabling selection of transmit amplifier 23 or receive amplifier 22 by short-circuiting to ground GND the bias signals of an input stage (cascode circuit) 31 or output stage (transistor) 41. However, according to an alternative, such an interruption in the control of input stage 31 or output stage 41 provided by bias sources B1 and B2 or B3 could be directly performed at the level of these sources.

The present invention advantageously enables reducing the bulk of the general transmit/receive system. Indeed, despite the apparent surface area increase introduced by the use of four one-way switches S1, S2, S3, S4 and of the corresponding control circuit 24, the general size of the system is reduced due to the replacing of two input (13, FIG. 1) and output (8) terminals by a single transmit/receive terminal 20, the suppressing of an impedance matching circuit, and above all the suppressing of a particularly bulky three-point bidirectional antenna switch (10).

For a frequency range from 400 MHz to 10 GHz, for example, for a frequency of 2.45 GHz, the various components may be the following:

low-noise amplifier 22:

inductance L30 ranging between 0.5 and 30 nH, for example (2.45-GHz case), 7 nH;

capacitance of capacitor C30 ranging between 0.1 and 10 pF, for example (2.45-GHz case), 0.3 pF;

inductance 32 ranging between 10 and 100 nH, for example, 20 nH;

power amplifier 23:

inductance L40 ranging between 0.5 and 30 nH, for example (2.45-GHz case), 6 nH;

capacitance of capacitor C40 ranging between 0.1 and 10 pF, for example (2.45-GHz case), 0.6 pF;

capacitance of virtual ground capacitor 45 ranging between 10 and 100 pF, for example (2.45-GHz case), 20 pF;

switches S1, S2, S3: NMOS transistors;

switch S4: PMOS transistor.

Of course, the present invention is likely to have various alterations, modifications, and improvements which will readily occur to those skilled in the art. In particular, those skilled in the art will know how to adjust the values and the different components to the operating frequency range. Those skilled in the art will also know how to choose the different one-way switches S1, S2, S3, and S4, as well as the associated control circuit 24, to obtain the previously-described turn-off and turn-on sequences. Similarly, those skilled in the art will know how to choose appropriate bias sources B1, B2, and B3.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A head of transmission-reception of a high-frequency signal made in the form of an integrated circuit comprising:
a transmit amplifier and a receive amplifier, wherein a transmit terminal of the transmit amplifier and a receive terminal of the receive amplifier are interconnected in said circuit in a transmit/receive terminal;
means for selecting one of the amplifiers; and
means for placing the other amplifier in a high impedance state, seen from the transmit/receive terminal.

2. The head of claim 1 wherein the means for selecting one of the amplifiers include controllable elements structured to interrupting a biasing signal of an input or output element of said amplifiers.

3. The head of claim 2 wherein one of said controllable elements is a one-way switch structured to being controlled to branch said biasing signal towards a ground of the integrated circuit.

4. The head of claim 3 wherein all controllable elements are one-way switches structured to being controlled to derive, towards the ground, at least one bias signal, and wherein the head includes a control circuit common to said switches.

5. The head of claim 2 wherein the means for selecting one of the amplifiers includes means for placing the one of the amplifiers in a high impedance state when it is not selected.

6. The head of claim 5 wherein the receive amplifier includes, connected in series between a high power supply and the ground, an inductor-capacitor oscillating circuit, a cascode assembly, and a current source; a gate of a MOS transistor belonging to said cascode assembly being connected to a bias source.

7. The head of claim 6 wherein the cascode assembly includes at least two transistors having respective gatesinterconnected to said bias source.

8. The head of claim 6 wherein the cascode assembly includes at least two transistors having respective gates individually connected to distinct bias sources.

9. The head of claim 1 wherein the transmit amplifier includes, interconnected between a high supply rail and a circuit ground, a one-way switch adapted to receiving a control signal from a control circuit, an oscillating circuit with an inductor and a first capacitor, an N-type MOS transistor, and a second capacitor being further interposed between the ground and a midpoint of a series connection of the one-way switch and of the oscillating circuit, a gate of the transistor receiving said bias signal and a transmit control signal coming from an input terminal of the transmit amplifier.

10. The head of claim 9 wherein a controllable one-way switch is interposed between the gate of said transistor and the ground.

11. A transmit/receive device integrated onto a single chip, comprising:
a transmit/receive terminal;
a transmit amplifier having an output connected to the terminal;
a receive amplifier having an input connected to the terminal;
a first circuit, configured to enable and disable the transmit amplifier; and
a second circuit, configured to enable and disable the receive amplifier.

12. The device of claim 11 wherein the transmit/receive terminal is connected to an antenna, external to the device.

13. The device of claim 12 wherein an impedance matching circuit is connected in series between the transmit/receive terminal and the antenna.

14. The device of claim 11 wherein the transmit amplifier further comprises:
a resonant circuit having a first terminal selectively coupled to a voltage source and a second terminal connected to the output of the transmit amplifier, the resonant circuit including an inductor and a capacitor; and
a transistor having a first conduction terminal connected to the second terminal of the resonant circuit, a second conduction terminal connected to a circuit ground, and a control terminal connected to a control circuit.

15. The device of claim 14 wherein the first circuit comprises a switch selectively coupling the first terminal of the resonant circuit to the voltage source, and a switch selectively coupling the control terminal to the circuit ground.

16. The device of claim 11 wherein the receive amplifier further comprises:
a resonant circuit having a first terminal connected to a voltage source, a second terminal connected to an output of the receive amplifier, the resonant circuit including an inductor and a capacitor;
a cascode circuit having a first terminal connected to a second terminal of the resonant circuit, a second terminal connected to the input of the receive amplifier, and a control terminal connected to a control circuit;
an inductor having a first terminal connected to the second terminal of the cascode circuit and a second terminal connected to a circuit ground.

17. The device of claim 16 wherein the second circuit comprises a switch selectively coupling the control terminal of the cascode circuit to the circuit ground.

18. The device of claim 11 wherein the first circuit is configured to disable the transmit amplifier while the receive amplifier is enabled and the second circuit is configured to disable the receive amplifier while the transmit amplifier is enabled.

19. The device of claim 11 wherein, when the transmit amplifier is disabled the transmit amplifier exhibits a high output impedance, and when the receive amplifier is disabled the receive amplifier exhibits a high input impedance.

20. A method, comprising:
enabling a transmit amplifier module of a circuit integrated onto a single chip;
disabling a receive amplifier module of the circuit;
transmitting a signal via a terminal of the circuit while the transmit module is enabled and the receive module is disabled;
disabling the transmit amplifier module of the circuit;
enabling the receive amplifier module of the circuit; and
receiving a signal via the terminal of the circuit while the receive module is enabled and the transmit module is disabled;

21. THE METHOD OF CLAIM 20 WHEREIN, WHEN THE TRANSMIT AMPLIFIER MODULE IS DISABLED IT EXHIBITS A HIGH OUTPUT IMPEDANCE, AND WHEN THE RECEIVE AMPLIFIER MODULE IS DISABLED IT EXHIBITS A HIGH INPUT IMPEDANCE.
